(19) United States
(12) Patent Application Publication
(10) Pub. No.: US 2019/0205837 A1
(43) Pub. Date: Jul. 4, 2019

(54) BOT FRAMEWORK FOR AUTONOMOUS DATA SOURCES

(71) Applicant: eBay Inc., San Jose, CA (US)

(72) Inventors: Vikram Tuli, San Jose, CA (US); Daniel Morales, San Jose, CA (US); John Joseph Kelly, San Jose, CA (US)

(21) Appl. No.: 15/859,444

(22) Filed: Dec. 30, 2017

(51) Int. Cl. G06Q 10/10; G06N 5/02

(52) U.S. Cl. CPC G06Q 10/105; G06N 5/022

(57) ABSTRACT

A bot framework receives a request message for data maintained by at least one of a plurality of autonomous data sources, and determines, based on a knowledge graph, a relationship between a first data set maintained by a first autonomous data source and a second data set maintained by a second autonomous data source. The bot framework transmits a first request to the first autonomous data source for a first set of corporate data using a first API. In response to receiving the first set of corporate data, the bot framework transmits a second request to the second autonomous data source for a second set of corporate data based on the first set of corporate data. The second request is transmitted using a second API. In response to receiving the second set of corporate data, the bot framework generates and transmits a response to the request message.

### TECHNICAL FIELD

An embodiment of the present subject matter relates generally to autonomous corporate data sources and, more specifically, to a bot framework for autonomous corporate data sources.

### BACKGROUND

Currently, companies provide internal corporate services to their employees using a variety of service providers (e.g., vendors). For example, a company may use a benefits service provided by one vendor to manage employee benefits, a payroll service provided by another vendor to manage employee pay, and a ticketing service provided by yet another vendor to manage trouble tickets. Each of these services is autonomous from the others and maintains specific data pertinent to the services they provide. However, these autonomous services do not have access to the data maintained by the other services. For instance, a payroll service has access to employee compensation, but does not have access to employee hierarchy and permission settings. Similarly, a Human Resources (HR) service has access to employee hierarchy and employee permission settings, but does not have access to employee compensation.

The autonomous services not only do not have access to the data maintained by the other services, they also do not have access to data describing the interconnections between the data maintained by the various services. As a result, these systems are not capable of answering questions that involve data accessed from multiple services. For example, to respond to an employee inquiry for the details of another employee's salary, a system should first access permission settings of the requesting user and then, if the requesting user has the appropriate permissions, access and return the requested salary data. An HR service can provide the permission settings and a payroll service can provide the salary information, however, without access to the data maintained by each service or an understanding of how the data interconnections, the system cannot handle these types of requests. This issue is further complicated by the various services using different Application Programming Interfaces (APIs) for communication. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows an example system configuration, wherein electronic devices communicate via a network for purposes of exchanging content and other data.

FIG. 2 is a block diagram of the bot framework, according to some example embodiments.

FIG. 3 is a ladder diagram showing communications between devices to access corporate data from autonomous data sources, according to some example embodiments.

FIG. 4 is a flowchart showing a method of using a bot framework to execute a specified action using a bot framework to access corporate data from autonomous data sources, according to certain example embodiments.

FIG. 5 is a flowchart showing a method of using a bot framework to access corporate data from autonomous data sources, according to certain example embodiments.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for a bot framework for autonomous corporate data sources. The bot framework enables interaction with corporate data maintained by multiple autonomous data sources. For example, the bot framework allows users to request an action be taken in associates with corporate data that is maintained by multiple autonomous data sources. A user uses their client device to transmit a request message to the bot framework to execute a desired action with respect to corporate data. The bot framework determines, from the received request message, the action requested by the user, and associated corporate data to access to perform the requested action. For example, the request message may request that a set of corporate data be returned to the user. As another example, the request message may request that specified corporate data be modified.

To accomplish this, the bot framework uses a knowledge graph that describes the data maintained by the autonomous data sources, and the interconnections between the data maintained by the autonomous data sources. In response to receiving a request message to perform am action in relation to specified corporate data, the bot framework uses the knowledge graph to identify the interconnections between the specified corporate data and other corporate data needed to properly perform the requested action, as well as to identify the location of the corporate data. For example, in response to receiving a request message to return the salary information of a user's direct reports, the bot framework uses the knowledge graph to determine that accessing the requested corporate data involves first requesting corporate data identifying the requesting user's direct reports, and then requesting the salary information for each identified direct report. The knowledge graph also identifies the locations of the corporate data (e.g., an HR service data source for the direct reports, and a payroll service data source for the salary information). The corporate bot uses this data to communicate with the appropriate autonomous data sources and request the corporate data needed to respond to the received request message.

Different autonomous data sources may use different APIs for communication. Accordingly, the bot framework is configured to identify and utilize the correct API to communicate with each autonomous data source. For instance, the bot framework uses one API to communicate with the HR service data source to request a listing of the user's direct reports, and a different API to communicate with the payroll service data source to request the salary information for each employee.

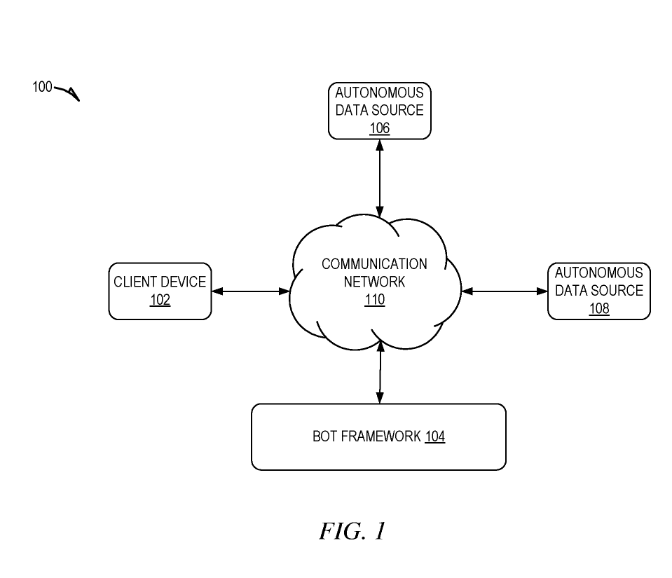

FIG. 1 shows an example system configuration 100, wherein electronic devices communicate via a network for purposes of exchanging content and other data. As shown, multiple devices (i.e., client device 102, bot framework 104, and autonomous data sources 106 and 108) are connected to a communication network 110 and configured to communicate with each other through use of the communication network 110. The communication network 110 is any type of network, including a local area network (“LAN”), such as an intranet, a wide area network (“WAN”), such as the internet, or any combination thereof. Further, the communication network 110 may be a public network, a private network, or a combination thereof. The communication network 110 is implemented using any number of communications links associated with one or more service providers, including one or more wired communication links, one or more wireless communication links, or any combination thereof. Additionally, the communication network 110 is configured to support the transmission of data formatted using any number of protocols.

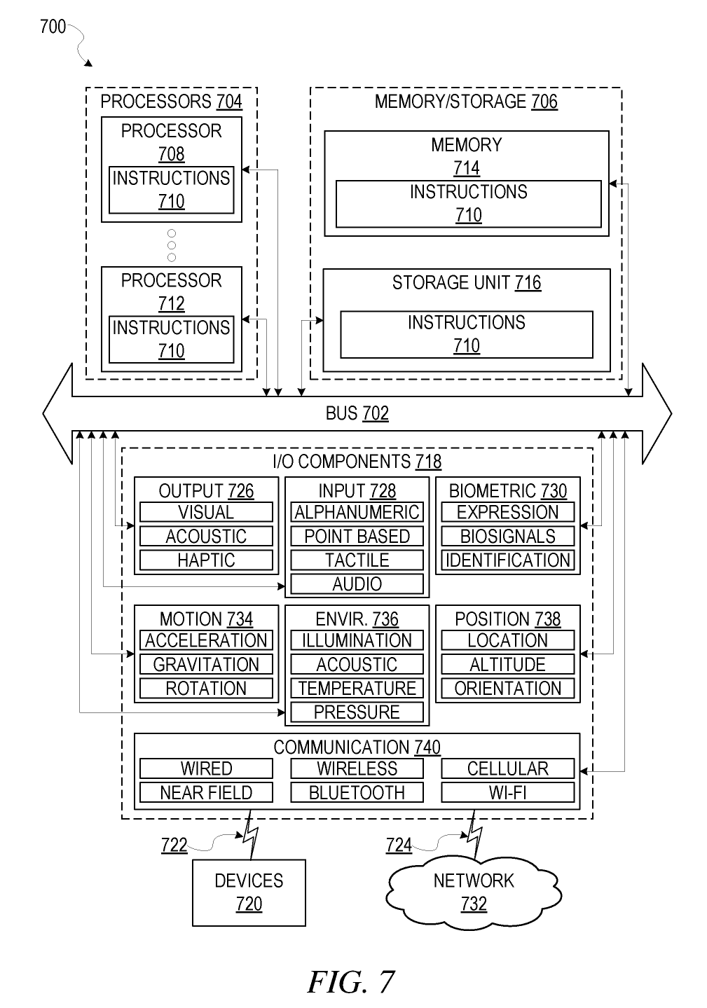

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of the machine 700 shown in FIG. 7.

To facilitate communication with other computing devices, a computing device includes a communication interface configured to receive a communication, such as a request, data, etc., from another computing device in network communication with the computing device and pass the communication along to an appropriate module running on the computing device. The communication interface also sends a communication to another computing device in network communication with the computing device.

In the system 100, users interact with the bot framework to execute requested actions in relation to data maintained by the autonomous data sources 106 and 108. For example, a user uses the client device 102 connected to the communication network 110 by direct and/or indirect communication to communicate with the bot framework 104 and utilize the functionality of the bot framework 104 to access, modify, etc., data maintained by the autonomous data sources 106 and 108. Although the shown system 100 includes only one client device 102 and only two autonomous data sources 106 and 108, this is only for ease of explanation and is not meant to be limiting. One skilled in the art would appreciate that the system 100 can include any number of client devices 102 and autonomous data sources 106 and 108. Further, the bot framework 104 may concurrently accept connections from and interact with any number of client devices 102 and autonomous data sources 106 and 108. The bot framework 104 supports connections from a variety of different types of client devices, such as desktop computers; mobile computers; mobile communications devices, e.g. mobile phones, smart phones, tablets; smart televisions; set-top boxes; and/or any other network enabled computing devices. Hence, the client device 102 may be of varying type, capabilities, operating systems, etc.

A user interacts with the bot framework 104 via a client-side application installed on the client device 102. In some embodiments, the client-side application includes a bot framework 104 specific component. For example, the component may be a stand-alone application, one or more application plug-ins, and/or a browser extension. However, the users may also interact with the bot framework 104 via a third-party application, such as a web browser, that resides on the client device 102 and is configured to communicate with the bot framework 104. In either case, the client-side application presents a user interface (UI) for the user to interact with the bot framework 104. For example, the user interacts with the bot framework 104 via a client-side application integrated with the file system or via a webpage displayed using a web browser application.

The bot framework 104 is one or more computing devices configured to facilitate interaction with corporate data maintained by multiple autonomous data sources 106 and 108. Corporate data is any data pertaining to a company. For example, corporate data includes data identifying and describing the employees of the company, the hierarchy of the employees within the company, employee salaries, employee titles, employee locations, employee benefit information, etc. Each autonomous data source 106 and 108 is part of a service implemented by a company, such as a Software as a Service (SaaS) solution. For example, autonomous data source 106 may be an HR service that manages employee data and hierarchies, while autonomous data source 108 may be a payroll service that manages employee payments. This is just one example of the types of SaaS solutions that the autonomous data sources 106 and 108 can provide, and is not meant to be limiting.

Each autonomous data source 106 and 108 is autonomous from the other, and maintains specific data pertinent to the services it provides. However, the autonomous data sources 106 and 108 do not have access to the data maintained by the other autonomous data sources. For instance, a payroll service has access to employee compensation, but does not have access to employee hierarchy and permission settings. Similarly, a Human Resources (HR) service has access to employee hierarchy and employee permission settings, but does not have access to employee compensation. Accordingly, the corporate data maintained by one autonomous data source 106 differs from the corporate data maintained by the other autonomous data source 108.

Different autonomous data sources 106 and 108 use different APIs for communication. For example, one of the autonomous data sources 106 uses one API for communication, while the other autonomous data source 108 uses a different API for communication.

The bot framework 104 enables interaction with the corporate data maintained by the autonomous data sources 106 and 108. For example, the bot framework 104 allows users to submit a request messages that a specific action be taken in respect to corporate data maintained by the autonomous data sources 106 and 108. To properly perform the requested action, the bot framework 104 may access corporate data from both autonomous data sources 106 and 108.

A user uses the client device 102 to transmit a request message to the bot framework 104. A request message is any type of communication that requests an action in relation to a set of corporate data. A request message may be in the form of a question, command, etc. Further, the request message may be a written request message typed by a user, or a voice request message spoken by a user. In any case, the bot framework 104 analyzes the received request message to identify the action that the user is requesting, as well as the corporate data associated with the action.

The bot framework 104 requests appropriate data from the autonomous data sources 106 and 108, which is used to perform the requested action. For example, if the requested action is to return a set of corporate data, the bot framework 104 accesses the requested data from the autonomous data sources 106 and 108, and generates a response message including the requested data. The bot framework 104 then transmits the response to the user's client device. As another example, if the requested action is to modify a set of corporate data, the bot framework 104 accesses corporate data from an autonomous data source 106 indicating permission levels associated with the user and, if the user has adequate permissions to modify the data, communicates with another autonomous data source 108 to execute the modification to the corporate data, as requested by the user.

The bot framework 104 maintains a knowledge graph that describes the data maintained by the autonomous data sources 106 and 108, and the interconnections between the data maintained by the autonomous data sources 106 and 108. For example, the knowledge graph describes access rules or steps associated with accessing specific corporate data, such as associated permission levels for accessing the corporate data, steps to be performed to properly access the corporate data, as well as data indicating where the corporate data is stored and what data is needed to properly access the corporate data.

The bot framework 104 uses the knowledge graph to execute an action requested by a user. For example, the bot framework 104 uses the knowledge graph to determine which corporate data to request from the autonomous data sources 106 and 108 to perform a requested action. For example, the bot framework 104 uses the knowledge graph to identify the interconnections between the requested data and other corporate data needed to properly execute the requested action. The bot framework 104 also uses the knowledge graph to identify the locations of the corporate data. As an example, in response to receiving a request message for the salary information of a user's direct reports, the bot framework 104 uses the knowledge graph to determine that the requested information involves first requesting corporate data from an autonomous data source 106 that maintains data about the requesting user's direct reports, and then using the direct report data to request the salary information for each identified direct report from an autonomous data source 108 that maintains employee salary information.

The bot framework 104 is configured to identify and utilize the correct API to communicate with each autonomous data source 106 and 108. For example, the bot framework 104 uses one API to communicate with one of the autonomous data sources 106 to request a listing of the user's direct reports, and a different API to communicate with the other autonomous data source 108 to request the salary information for each employee.

The bot framework 104 uses the corporate data accessed from the autonomous data sources 106 and 108 to execute the requested action (e.g., to return corporate data, modify corporate data, etc.). In some instances, the bot framework 104 generates a response message to the user request message. For example, the response message indicates that the requested action was successfully completed. As another example, the response message provides the user with requested corporate data. The response message can be a text response presented to the user on an output screen of the client device 102. Alternatively, the response message may be a voice response that is played for the user using output speakers of the client device 102.

The bot framework 104 provides an improvement by accessing corporate data from the autonomous data sources 106 and 108, rather than attempting to copy the data maintained by the autonomous data sources 106 and 108 to a local data storage maintained by the bot framework 104. Attempting to copy the corporate data to a local storage often result in incomplete data, as well as being laborious, untimely and many instances inaccurate. Collecting data requires constant data loads, data management, data governance and reconciliation, This process becomes expensive over time as source systems change and the data becomes stale and out of synch.

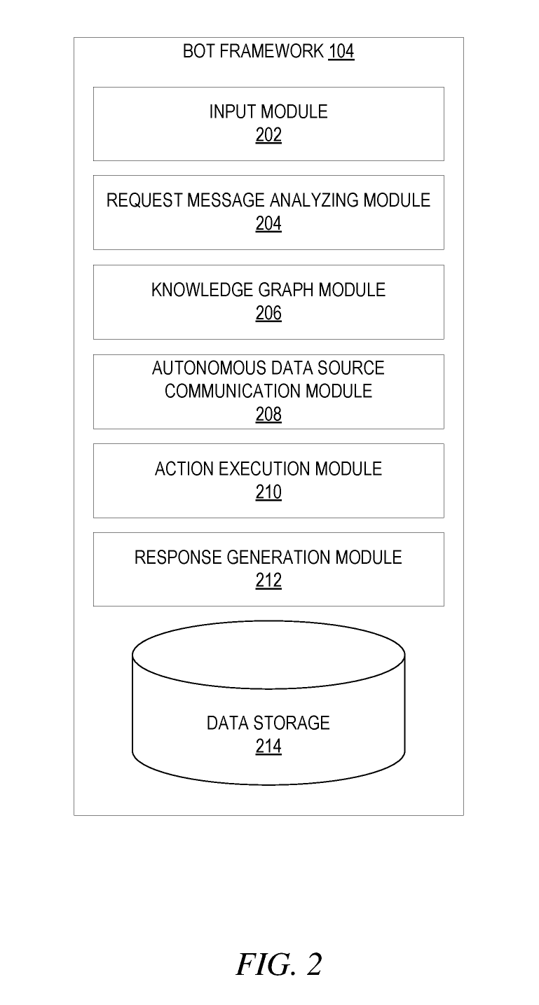

FIG. 2 is a block diagram of the bot framework 104, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the bot framework 104 to facilitate additional functionality that is not specifically described herein. Furthermore, the various functional modules depicted in FIG. 2 may reside on a single computing device or may be distributed across several computing devices in various arrangements such as those used in cloud-based architectures.

As shown, the bot framework 104 includes an input module 202, a request message analyzing module 204, a knowledge graph module 206, an autonomous data source communication module 208, an action execution module 210, a response generation module 212, and a data storage 214.

The input module 202 receives a request message from a client device 102. A request message is any type of communication that requests an action in relation to a set of corporate data. A request message may be in the form of a question, command, etc. Further, the request message may be a written request message typed by a user, a voice request message spoken by a user, etc. In some implementations, the input module 202 provides the user with a request message interface that enables the user to enter a request message. For example, the request message interface includes user interface elements, such as buttons, text boxes, etc., that the user uses to type in a request message. In any case, once a user has used their client device 102 to generate a request message, the request message is transmitted by the client device 102 to the bot framework 104, where it is received by the input module 202.

The request message analyzing module 204 analyzes a received request message to identify an action requested by a user and corporate data associated with the request. The request message analyzing module 204 uses any of a variety of know natural language processing techniques to analyze a received request message. For example, the request message analyzing module 204 may analyze a request message based on a set of known keywords to identify a requested action or corporate data. For example, given the request message ‘when is my annual bonus paid,’ the request message analyzing module 204 determines that the keywords ‘annual bonus’ correspond to corporate data describing pay and, more specifically, bonus payments. Further, the request message analyzing module 204 further determines that the keywords ‘when’ and ‘paid’ indicate that user is requesting that the bot framework 104 perform the action of returning the payment date to the user. As another example, given the request message ‘how many vacations day do I have left’ the request message analyzing module 204 determines that the keyword ‘how many’ indicates that the user is requesting that the bot framework 104 perform the action of returning data to the user, and the keywords ‘vacation days’ correspond to corporate data describing vacation days.

These are just two simple examples of how the request message analyzing module 204 analyzes a request message to identify the requested action and associated corporate data, and are not meant to be limiting. The request message analyzing module 204 may use any of a variety of natural language processing techniques to analyze a request message, and this disclosure anticipates all such embodiments.

The knowledge graph module 206 uses a knowledge graph to determine the process for executing an action requested by a user. The knowledge graph is stored in the data storage 214. The knowledge graph describes the data maintained by the autonomous data sources 106 and 108, and the interconnections between the data maintained by the autonomous data sources 106 and 108. For example, the knowledge graph describes an access procedure associated with accessing specific corporate data, such as associated permission levels for accessing the corporate data, steps to be performed to properly access the corporate data, as well as data indicating where the corporate data is stored and what data is needed to properly access the corporate data.

The knowledge graph module 206 uses the action and associated corporate data identified by the request message analyzing module 204 to analyze the knowledge graph and determine the process to execute the requested action. For example, the knowledge graph module 206 uses the identified corporate data to determine the interconnections between the corporate data and other corporate data. The interconnections between corporate data indicates how the disparate sets of corporate data relate to each other. For instance, the knowledge graph may indicate an interconnection between a set of sensitive corporate data and a set of user permission settings indicating the permissions granted to various users. The interconnection indicates that to access the sensitive corporate data, that a user is required to be assigned certain user permission settings. As another example, the interconnection may indicate subsets of the sensitive corporate data that a user may access based on the user permission setting assigned to the user.

In addition to identifying the interconnections between corporate data, the knowledge graph also indicates access steps or a procedure for executing a specified action in relation to a set of corporate data. For example, the knowledge graph indicates an order in which corporate data should be requested and used to execute a specified action. For instance, the knowledge graph indicates that to access sensitive corporate data, the user's permission setting should be accessed first, and then used to request the sensitive corporate data.

Additionally, the knowledge graph may indicate specific data items needed to successfully request other corporate data. For instance, a user's personal data may be stored anonymously by an autonomous data source 106 such that the personal data is associate with a unique identifier rather than the user's name. The knowledge graph indicates that to successfully access the personal data, first the unique identifier assigned to the user should be accessed from a different autonomous data source 108, and then the unique identifier should be used to request the personal data from the autonomous data source 106 that maintains the personal data.

The knowledge graph also indicates the location of the corporate data. For example, the knowledge graph indicates the autonomous data source 106, 108, that maintains the specified corporate data.

The knowledge graph module 206 communicates with the data storage 214 to access the knowledge graph and analyze the knowledge graph based on the requested action and corporate data identified from a request message. For example, the knowledge graph module 206 searches the knowledge graph based on the identified corporate data. Once the corporate data is identified in the knowledge graph, the knowledge graph module 206 determines the interconnections between the corporate data and other corporate data, the access process for accessing the corporate data, as well as the location of the corporate data.

Using a knowledge graph allows for metadata to be abstracted from the autonomous data sources 106 and 108 into a common repository. This allows a query intent that spans across myriad of corporate applications to be garnered. Without using knowledge graph, each system would struggle to interpret the entire intent and would return incomplete or inaccurate data. Accordingly, using a knowledge provides several technical improvements. Specifically, using the knowledge graph allows for accessing corporate data from the autonomous data sources 106 and 108, rather than having to copy all of the corporate data from the autonomous data sources 106 and 108 into a local storage. Copying the corporate data is both time consuming and resource intensive. Hence, using the knowledge graph reduces resource usage and increases overall system speed. Using the knowledge graph also eliminates the need to continuously monitor and synchronize the corporate data stored in the local storage with the corporate data that is stored in the autonomous data sources 106 and 108. Synchronizing the corporate data is also time consuming and resources intensives, and further is ineffective for complete accuracy. Accordingly, using the knowledge graph further increases system speed and data accuracy by reducing the need to synchronize corporate data.

The knowledge graph is improved using a loopback feature of artificial intelligence (AI) and machine learning (ML). This makes the common repository more versatile and accurate as it learns on the missing relations and harvests them for future needs. The ML algorithms learn and train the common repository model to join various dynamic APIs that improve with time so that the knowledge graph knows what APIs to invoke in what sequence, to gather and assemble corporate data in a shortest duration of time from the most trusted autonomous data source. Ultimately, the knowledge graph will be able to predict the common business scenarios and will optimize itself with affinity scores.

Dynamic APIs mix and match APIs to provide the correct corporate data. Dynamic APIS provide a complete and understandable description of the corporate data in the API, which provides users with the ability to ask for the corporate data they need.

The autonomous data source communication module 208 communicates with various autonomous data sources 106 and 108 to perform specified commands. As each autonomous data source 106 and 108 are provided by different vendors, the APIs used by the autonomous data sources 106 and 108 differ from each other. Accordingly, to successfully communicate with each autonomous data source 106 and 108, the autonomous data source communication module 208 uses the API calls used by the autonomous data source. To accomplish this, the autonomous data source communication module 208 uses an API listing that identifies which API library to use for each autonomous data source. The API listing is stored in the data storage 214.

The API listing identifies target APIs based on the autonomous data source 106 and 108, subject, etc. For example, the API listing may include target APIs for corporate data about employees (HR, payroll, expenses, travel, organizational structure, etc.), tickets, etc. The API listing may include dynamic APIs that join APIs for multiple autonomous data sources 106 and 108. For example, the dynamic APIs should be stackable.

The autonomous data source communication module 208 access the API listing form the data storage to determine which API calls to use for a specified autonomous data source. Accordingly, the autonomous data source communication module 208 may use one API call to request corporate data from one autonomous data source 106, while using a different API call to request corporate data from the other autonomous data source 108.

The action execution module 210 executes a requested action based on the information gathered from the knowledge graph. For example, the action execution module 210 causes the autonomous data source communication module 208 to request corporate data from one or more of the autonomous data sources 106 and 108 based on the access process identified by the knowledge graph. This includes accessing corporate data from the autonomous data sources 106 and 108 in a specified order, using corporate data received from one autonomous data source 106 to access corporate data from the other autonomous data source 108, etc.

The action execution module 210 may further perform other operations using the corporate data to properly execute the requested action. For example, the action execution module 210 may compare received corporate data to thresholds, determine if data matches, etc. In a specific example, to determine whether a user's bonus will be larger than their previous bonus, the action execution module 210 gathers corporate data describing the expected value of the upcoming bonus and the value of the previous year's bonus, and then compares the two to determine whether the upcoming bonus is greater than the previous year's bonus.

The response generation module 212 generates a response message to provide to a user in response to a request message. The response message may include corporate data requested by the user, a formulated answer to a question asked by the user, a confirmation that the requested action was completed, etc. The response generation module 212 transmits the response message to the user's client device 102, where the response message is presented to the user. The response message may be in either text or voice form. For example, a text based response message is presented to the user on a display of the client device 102. Alternatively, a voice based response message is played for the user using speakers of the client device 102.

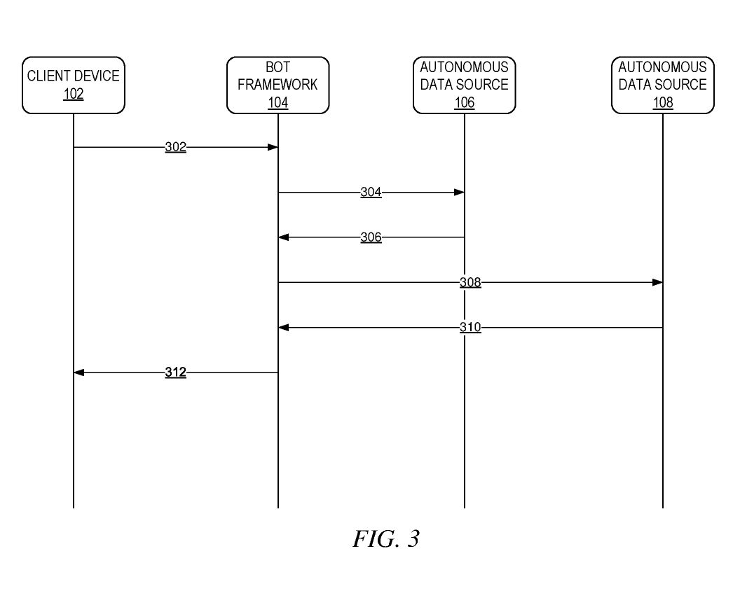

FIG. 3 is a ladder diagram showing communications between devices to access corporate data from autonomous data sources, according to some example embodiments. To avoid obscuring the inventive subject matter with unnecessary detail, various functional components (e.g., modules) that are not germane to conveying an understanding of the inventive subject matter have been omitted from FIG. 3. However, a skilled artisan will readily recognize that various additional functional components may be supported by the shown devices to facilitate additional functionality that is not specifically described herein. Furthermore, the various functional devices depicted in FIG. 3 may reside on a single computing device or may be distributed across several computing devices in various arrangements such as those used in cloud-based architectures.

As shown, the client device 102 sends a request message 302 to the bot framework. The request message 302 is any type of communication that requests an action in relation to a set of corporate data. The request message 302 may be in the form of a question, command, etc. Further, the request message 302 may be a written request message typed by a user, a voice request message spoken by a user, etc.

The bot framework 104 analyzes the request message 302 to identify a requested action and associated corporate data. The bot framework 104 then uses a knowledge graph to determine how to execute the requested action. For example, the knowledge graph identifies that the bot framework 104 should access corporate data from autonomous data sources 106 and 108 to properly execute the requested action. Further, the knowledge graph indicates that corporate data should first be accessed from one of the autonomous data sources 106, and then used to access corporate data from a second autonomous data source 108.

Accordingly, the bot framework 104 transmits a request 304 to the autonomous data source 106 for a first set of corporate data maintained by the autonomous data source 106. The request 304 is transmitted using an API supported by the autonomous data source 106. In response, the autonomous data sources 106 transmits a reply message 306 to the bot framework 104 that includes the requested first set of corporate data.

The bot framework 104 then transmits a second request 308 to the other autonomous data source 108 for a second set of corporate data maintained by the other autonomous data source 108. The second request 308 includes corporate data received from the first autonomous data source 106, which is used by the other autonomous data source 108 to access the requested second set of corporate data. For example, the corporate data included in the second request 308 may be user permission setting used by the autonomous data source 108 to determine whether the user should be provided the requested corporate data or determine what subset of the requested corporate data should be provided to the user. As another example, the corporate data included in the second request 308 may be a unique identifier used by the autonomous data source 108 to identify the second set of corporate data.

The second request 308 is transmitted using a different API that is supported by the other autonomous data source 108. Thus, the API used in the first request 304 and the second request 308 are different. This is because the autonomous data sources 106 and 108 are associated with different vendors and hence use their own API libraries.

The autonomous data source 108 transmits a second reply message 310 to the bot framework 104 that includes the requested second set of corporate data. The bot framework 104 uses the received second set of corporate data to execute the requested action and generate a response 312 to the request message, which is transmitted back to the client device 102.

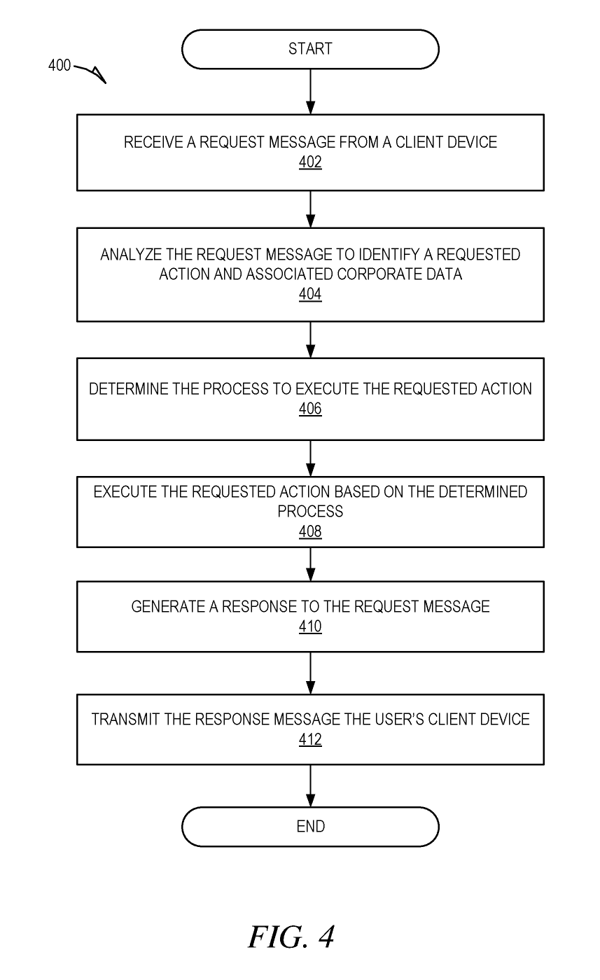

FIG. 4 is a flowchart showing a method 400 of using a bot framework to execute a specified action, according to certain example embodiments. The method 400 may be embodied in computer readable instructions for execution by one or more processors such that the operations of the method 400 may be performed in part or in whole by the bot framework 104; accordingly, the method 400 is described below by way of example with reference thereto. However, it shall be appreciated that at least some of the operations of the method 400 may be deployed on various other hardware configurations and the method 400 is not intended to be limited to the bot framework 104.

At operation 402, the input module 202 receives a request message from a client device 102. A request message is any type of communication that requests an action in relation to a set of corporate data. A request message may be in the form of a question, command, etc. Further, the request message may be a written request message typed by a user, a voice request message spoken by a user, etc. In some implementations, the input module 202 provides the user with a request message interface that enables the user to enter a request message. For example, the request message interface includes user interface elements, such as buttons, text boxes, etc., that the user uses to type in a request message. In any case, once a user has used their client device 102 to generate a request message, the request message is transmitted by the client device 102 to the bot framework 104, where it is received by the input module 202.

At operation 404, the request message analyzing module 204 analyzes the request message to identify a requested action and associated corporate data. The request message analyzing module 204 uses any of a variety of know natural language processing techniques to analyze a received request message. For example, the request message analyzing module 204 may analyze a request message based on a set of known keywords to identify a requested action or corporate data. For example, given the request message ‘when is my annual bonus paid,’ the request message analyzing module 204 determines that the keywords ‘annual bonus’ correspond to corporate data describing pay and, more specifically, bonus payments. Further, the request message analyzing module 204 further determines that the keywords ‘when’ and ‘paid’ indicate that user is requesting that the bot framework 104 perform the action of returning the payment date to the user. As another example, given the request message ‘how many vacations day do I have left’ the request message analyzing module 204 determines that the keyword ‘how many’ indicates that the user is requesting that the bot framework 104 perform the action of returning data to the user, and the keywords ‘vacation days’ correspond to corporate data describing vacation days.

These are just two simple examples of how the request message analyzing module 204 analyzes a request message to identify the requested action and associated corporate data, and are not meant to be limiting. The request message analyzing module 204 may use any of a variety of natural language processing techniques to analyze a request message, and this disclosure anticipates all such embodiments.

At operation 406, the knowledge graph module 206, determines the process to execute the requested action. The knowledge graph describes the data. maintained by the autonomous data sources 106 and 108, and the interconnections between the data maintained by the autonomous data sources 106 and 108. For example, the knowledge graph describes an access procedure associated with accessing specific corporate data, such as associated permission levels for accessing the corporate data, steps to be performed to properly access the corporate data, as well as data indicating where the corporate data is stored and what data is needed to properly access the corporate data.

The knowledge graph module 206 uses the action and associated corporate data identified by the request message analyzing module 204 to analyze the knowledge graph and determine the process to execute the requested action. For example, the knowledge graph module 206 uses the identified corporate data to determine the interconnections between the corporate data and other corporate data. The interconnections between corporate data indicates how the disparate sets of corporate data relate to each other. For instance, the knowledge graph may indicate an interconnection between a set of sensitive corporate data and a set of user permission settings indicating the permissions granted to various users. The interconnection indicates that to access the sensitive corporate data, that a user is required to be assigned certain user permission settings. As another example, the interconnection may indicate subsets of the sensitive corporate data that a user may access based on the user permission setting assigned to the user.

In addition to identifying the interconnections between corporate data, the knowledge graph also indicates access steps or a procedure for executing a specified action in relation to a set of corporate data. For example, the knowledge graph indicates an order in which corporate data should be requested and used to execute a specified action. For instance, the knowledge graph indicates that to access sensitive corporate data, the user's permission setting should be accessed first, and then used. to request the sensitive corporate data.

Additionally, the knowledge graph may indicate specific data items needed to successfully request other corporate data. For instance, a user's personal data may be stored anonymously by an autonomous data source 106 such that the personal data is associate with a unique identifier rather than the user's name. The knowledge graph indicates that to successfully access the personal data, first the unique identifier assigned to the user should be accessed from a different autonomous data source 108, and then the unique identifier should be used to request the personal data from the autonomous data source 106 that maintains the personal data.

The knowledge graph also indicates the location of the corporate data. For example, the knowledge graph indicates the autonomous data source 106, 108, that maintains the specified corporate data.

The knowledge graph module 206 communicates with the data storage 214 to access the knowledge graph and analyze the knowledge graph based on the requested action and corporate data identified from a request message. For example, the knowledge graph module 206 searches the knowledge graph based on the identified corporate data. Once the corporate data is identified in the knowledge graph, the knowledge graph module 206 determines the interconnections between the corporate data and other corporate data, the access process for accessing the corporate data, as well as the location of the corporate data.

At operation 408, the action execution module 210, executes the requested action based on the determined process. For example, the action execution module 210 causes the autonomous data source communication module 208 to request corporate data from one or more of the autonomous data sources 106 and 108 based on the access process identified by the knowledge graph. This includes accessing corporate data from the autonomous data sources 106 and 108 in a specified order, using corporate data received from one autonomous data source 106 to access corporate data from the other autonomous data source 108, etc.

The action execution module 210 may further perform other operations using the corporate data to properly execute the requested action. For example, the action execution module 210 may compare received corporate data to thresholds, determine if data matches, etc. In a specific example, to determine whether a user's bonus will be larger than their previous bonus, the action execution module 210 gathers corporate data describing the expected value of the upcoming bonus and the value of the previous year's bonus, and then compares the two to determine whether the upcoming bonus is greater than the previous year's bonus.

At operation 410, the response generation module 212, generates a response to the request message. The response message may include corporate data requested by the user, a formulated answer to a question asked by the user, a confirmation that the requested action was completed, etc.

At operation 412, the response generation module 212 transmits the response message to the user's client device 102. The client device 102 then presents the response message to the user. The response message may be in either text or voice form. For example, a text based response message is presented to the user on a display of the client device 102. Alternatively, a voice based response message is played for the user using speakers of the client device 102,

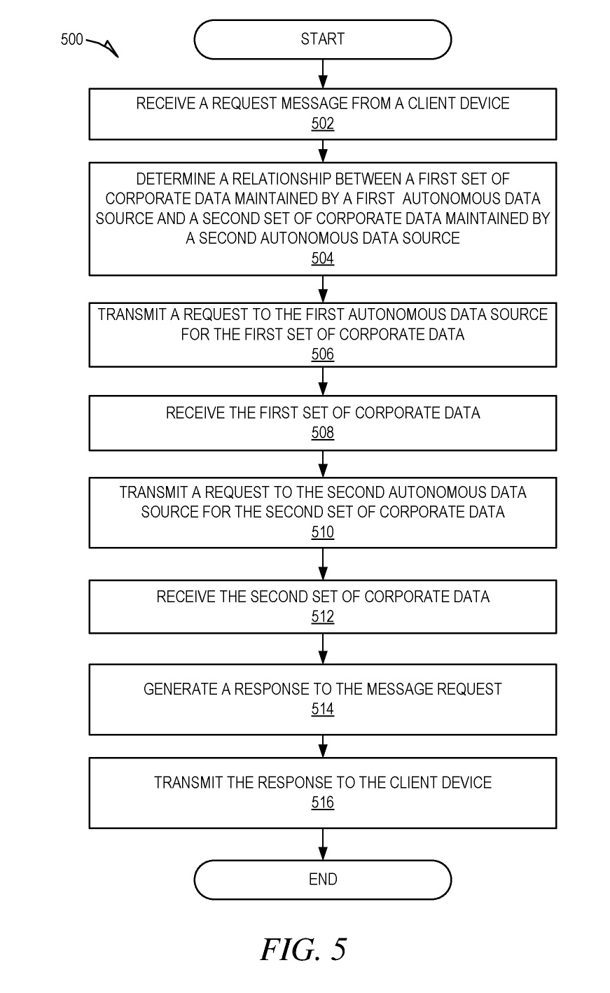

FIG. 5 is a flowchart showing a method 500 of using a bot framework to access corporate data from autonomous data sources, according to certain example embodiments. The method 500 may be embodied in computer readable instructions for execution by one or more processors such that the operations of the method 500 may be performed in part or in whole by the bot framework 104; accordingly, the method 500 is described below by way of example with reference thereto. However, it shall be appreciated that at least some of the operations of the method 500 may be deployed on various other hardware configurations and the method 500 is not intended to be limited to the bot framework 104.

At operation 502, the input module 202 receives a request message from a client device 102. The request message requests that a set of corporate data be returned to the user. The request message is a question submitted by a user using corporate bot service that provides corporate data associated with a first corporation.

At operation 504, the knowledge graph module 206 determines a relationship between a first set of corporate data maintained by a first autonomous data source 106 and a second set of corporate data maintained by a second autonomous data source 108. The knowledge graph module 206 uses a knowledge graph to determine the relationship between the first set of corporate data and the second set of corporate data. The relationship indicated interconnections between the sets of corporate data. The second set of corporate data is the corporate data being requested by the user, and the first set of corporate data is other corporate data needed to access the second set of corporate data. For example, the first set of corporate data includes user permission settings for the second set of corporate data maintained by the second autonomous data source 108. This may include user permission settings for the user that submitted the request message.

At operation 506, the autonomous data source communication module 208 transmits a request to the first autonomous data source 106 for the first set of corporate data. The first request is transmitted based on the message request and the relationship between the first data set and the second data set, Further, the first request is transmitted using a first API associated with the first autonomous data source 106.

At operation 508, the autonomous data source communication module 208 receives the first set of corporate data.

At operation 510, the autonomous data source communication module 208 transmits a request to the second autonomous data source 108 for the second set of corporate data. The second request is based on the relationship between the first data set and the second data set and the first set of corporate data received from the first autonomous data source 106. For example, the second request includes the user permission settings for the user. The second request is transmitted using a second API associated with the second autonomous data source. The second API may be different than the first API.

The user permission settings are included in the second request for use by the second autonomous data source 108 to determine whether the user is authorized to access corporate data, as well as to determine which corporate data to return to the user. For example, a user that is a manager may be granted higher permissions than the permissions granted to his/her direct reports. The higher permissions granted to the manager enable the manager to access certain corporate data that his/her direct reports are not granted access to. For example, the manager may have access to the salary information of each member of the team. Alternatively, his/her direct reports may only have access to their individual salary information. The second autonomous data source 108 uses the received user permission settings to determine the corporate data that the user is authorized to view. As a result, the manger would receive their own salary information, as well as the salary information of their direct report, whereas the direct reports would receive only their own salary information.

As another example, one of the manager's direct reports may have direct reports of their own. In this case, the sub-manager may be granted access to their salary information as well as the salary information of their direct reports, while the manager above the sub-manager is granted access to an even larger group of employees, including the sub-manager and the sub-manager's direct reports. The second autonomous data source 108 uses the received user permission settings to determine the corporate data that the user is authorized to view. As a result, the sub-manger would receive their own salary information, as well as the salary information of the sub-manager's direct report, whereas the manager above the sub-manager would receive their own salary information and the salary information of the manager's direct reports, which includes the sub-manager and the sub-manager's direct reports.

At operation 512, the autonomous data source communication module 208 receives the second set of corporate data. The second set of corporate data includes data maintained by the second autonomous data source 108 that the user is authorized to access based on the user permission settings for the user. As explained above, the second autonomous data source 108 uses the user permission settings included in the second request to identify the corporate data that the requesting user is authorized to access. Accordingly, the set of corporate data provided to a requesting user is customized to the user based on the user's permission settings.

At operation 514, the response generation module 212 generates a response to the message request. The response message includes the second set of corporate data requested by the user.

At operation 516, the response generation module 212 transmits the response to the client device 102.

### Software Architecture

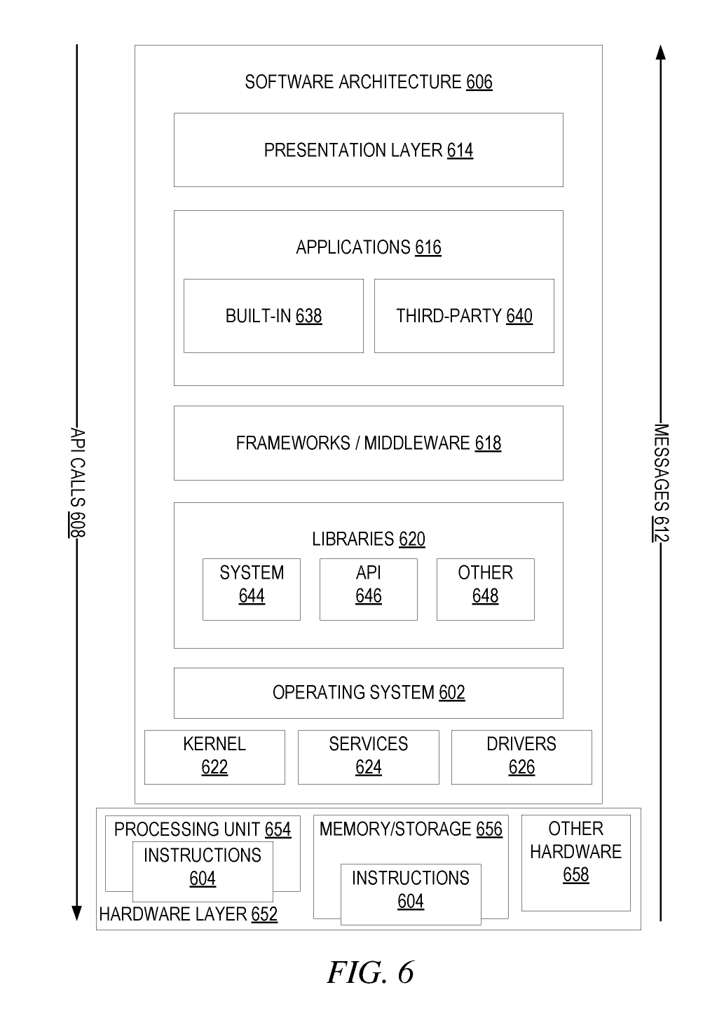

FIG. 6 is a block diagram illustrating an example software architecture 606, which may be used in conjunction with various hardware architectures herein described. FIG. 6 is a non-limiting example of a software architecture 606 and it will be appreciated that many other architectures may be implemented to facilitate the functionality described herein. The software architecture 606 may execute on hardware such as machine 700 of FIG. 7 that includes, among other things, processors 704, memory 714, and (input/output) I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage modules memory/storage 656, which also have executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke API calls 608 through the software stack and receive a response such as messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624 and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphic user interface (GUI) functions, high-level resource management, high-level location services, and so forth. The frameworks/middleware 618 may provide a broad spectrum of other APIs that may be used by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™ ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624 and/or drivers 626), libraries 620, and frameworks/middleware 618 to create user interfaces to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions 604 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 700 capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth, The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 738 may include location sensor components (e.g., a UPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via coupling 724 and coupling 722, respectively. For example, the communication components 740 may include a network interface component or other suitable device to interface with the network 732. In further examples, communication components 740 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include radio frequency identification (RFD) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 710 for execution by the machine 700, and includes digital or analog communications signals or other intangible medium to facilitate communication of such instructions 710. Instructions 710 may be transmitted or received over the network 732 using a transmission medium via a network interface device and using any one of a number of well-known transfer protocols.

“CLIENT DEVICE” in this context refers to any machine 700 that interfaces to a communications network 732 to obtain resources from one or more server systems or other client devices. A client device 102 may be, but is not limited to, a mobile phone, desktop computer, laptop, PDAs, smart phones, tablets, ultra books, netbooks, laptops, multi-processor systems, microprocessor-based or programmable consumer electronics, game consoles, STBs, or any other communication device that a user may use to access a network 732.

“COMMUNICATIONS NETWORK” in this context refers to one or more portions of a network 732 that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 732 or a portion of a network 732 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 710 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 710. The term “machine-readable medium” shall also be taken to include any medium, or combination of multiple media, that is capable of storing instructions 710 (e.g., code) for execution by a machine 700, such that the instructions 710, when executed by one or more processors 704 of the machine 700, cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 704) may be configured by software (e.g., an application 816 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 704 or other programmable processor 704. Once configured by such software, hardware components become specific machines 700 (or specific components of a machine 700) uniquely tailored to perform the configured functions and are no longer general-purpose processors 704. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time, For example, where a hardware component comprises a general-purpose processor 704 configured by software to become a special-purpose processor, the general-purpose processor 704 may be configured as respectively different special-purpose processors (e.g., comprising different hardware components) at different times. Software accordingly configures a particular processor or processors 704, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 702) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information), The various operations of example methods described herein may be performed, at least partially, by one or more processors 704 that are temporarily configured (e.g., by software) or permanently configured to perform the relevant operations. Whether temporarily or permanently configured, such processors 704 may constitute processor-implemented components that operate to perform one or more operations or functions described herein. As used herein, “processor-implemented component” refers to a hardware component implemented using one or more processors 704. Similarly, the methods described herein may be at least partially processor-implemented, with a particular processor or processors 704 being an example of hardware. For example, at least some of the operations of a method may be performed by one or more processors 704 or processor-implemented components. Moreover, the one or more processors 704 may also operate to support performance of the relevant operations in a “cloud computing” environment or as a “software as a service” (SaaS). For example, at least some of the operations may be performed by a group of computers (as examples of machines 700 including processors 704), with these operations being accessible via a network 732 (e.g., the Internet) and via one or more appropriate interfaces (e.g., an API). The performance of certain of the operations may be distributed among the processors 704, not only residing within a single machine 700, but deployed across a number of machines 700. In some example embodiments, the processors 704 or processor-implemented components may be located in a single geographic location (e.g., within a home environment, an office environment, or a server farm). In other example embodiments, the processors 704 or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine 700. A processor 704 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof A processor may further be a multi-core processor having two or more independent processors 704 (sometimes referred to as “cores”) that may execute instructions 710 contemporaneously.

What is claimed:

1. A method comprising:
receiving, by a bot framework, a request message for data maintained by at least one of a plurality of autonomous data sources, the request message received from a client device;
determining, based on a knowledge graph maintained by the bot framework, a relationship between a first data set maintained by a first autonomous data source and a second data set maintained by a second autonomous data source;
transmitting a first request to the first autonomous data source for a first set of corporate data maintained by the first autonomous data source, the first request being based on the request message and the relationship between the first data set and the second data set, the first request being transmitted using a first Application Programming Interface (API) associated with the first autonomous data source;
receiving the first set of corporate data from the first autonomous data source in response to the first request;
transmitting a second request to the second autonomous data source for a second set of corporate data maintained by the second autonomous data source, the second request being based on the relationship between the first data set and the second data set and the first set of corporate data received from the first autonomous data source, the second request being transmitted using a second API associated with the second autonomous data source;
receiving the second set of corporate data from the second autonomous data source in response to the second request;
generating a response to the request message based on at least the second set of corporate data; and
transmitting, to the client device, the response to the request message.

2. The method of claim 1, wherein the request message is a question submitted by a user using corporate bot service that provides corporate data associated with a first corporation.

3. The method of claim 2, wherein the first data set maintained by the first autonomous data source includes user permission settings for the second data set maintained by the second autonomous data source.

4. The method of claim 3, wherein the first set of corporate data includes user permission settings for the user that submitted the request message.

5. The method of claim 4, wherein the second request includes the user permission settings for the user.

6. The method of claim 5, wherein the second set of corporate data includes data maintained by the second autonomous data source that the user is authorized to access based on the user permission settings for the user.

7. The method of claim 1, wherein the first API is different than the second API.

8. A bot framework comprising:
one or more computer processors; and
one or more computer-readable mediums storing instructions that, when executed by the one or more computer processors, cause the bot framework to perform operations comprising:
receiving a request message for data maintained by at least one of a plurality of autonomous data sources, the request message received from a client device;
determining, based on a knowledge graph maintained by the bot framework, a relationship between a first data set maintained by a first autonomous data source and a second data set maintained by a second autonomous data source:
transmitting a first request to the first autonomous data source for a first set of corporate data maintained by the first autonomous data source, the first request being based on the request message and the relationship between the first data set and the second data set, the first request being transmitted using a first Application Programming interface (API) associated with the first autonomous data source;
receiving the first set of corporate data from the first autonomous data source in response to the first request;
transmitting a second request to the second autonomous data source for a second set of corporate data maintained by the second autonomous data source, the second request being based on the relationship between the first data set and the second data set and the first set of corporate data received from the first autonomous data source, the second request being transmitted using a second API associated with the second autonomous data source;
receiving the second set of corporate data from the second autonomous data source in response to the second request;
generating a response to the request message based on at least the second set of corporate data; and
transmitting, to the client device, the response to the request message.

9. The bot framework of claim 8, wherein the request message is a question submitted by a user using corporate bot service that provides corporate data. associated with a first corporation.

10. The bot framework of claim 9, wherein the first data set maintained by the first autonomous data source includes user permission settings for the second data set maintained by the second autonomous data source.

11. The bot framework of claim 10, wherein the first set of corporate data includes user permission settings for the user that submitted the request message,

12. The bot framework of claim 11, wherein the second request includes the user permission settings for the user.

13. The bot framework of claim 12, wherein the second set of corporate data includes data maintained by the second autonomous data source that the user is authorized to access based on the user permission settings for the user.

14. The bot framework of claim 8, wherein the first API is different than the second API.

15. A non-transitory computer-readable medium storing instructions that, when executed by one or more computer processors of a bot framework, cause the bot framework to perform operations comprising:
receiving a request message for data maintained by at least one of a plurality of autonomous data sources, the request message received from a client device;
determining, based on a knowledge graph maintained by the bot framework, a relationship between a first data set maintained by a first autonomous data source and a second data set maintained by a second autonomous data source;
transmitting a first request to the first autonomous data source for a first set of corporate data maintained by the first autonomous data source, the first request being based on the request message and the relationship between the first data set and the second data set, the first request being transmitted using a first Application Programming Interface (API) associated with the first autonomous data source;
receiving the first set of corporate data from the first autonomous data source in response to the first request;
transmitting a second request to the second autonomous data source for a second set of corporate data maintained by the second autonomous data source, the second request being based on the relationship between the first data set and the second data set and the first set of corporate data received from the first autonomous data source, the second request being transmitted using a second API associated with the second autonomous data source;
receiving the second set of corporate data from the second autonomous data source in response to the second request;
generating a response to the request message based on at least the second set of corporate data; and
transmitting, to the client device, the response to the request message.

16. The non-transitory computer-readable medium of claim 15, wherein the request message is a question submitted by a user using corporate bot service that provides corporate data associated with a first corporation.

17. The non-transitory computer-readable medium of claim 16, wherein the first data set maintained by the first autonomous data source includes user permission settings for the second data set maintained by the second autonomous data source.

18. The non-transitory computer-readable medium of claim 17, wherein the first set of corporate data includes user permission settings for the user that submitted the request message.

19. The non-transitory computer-readable medium of claim 18, wherein the second request includes the user permission settings for the user.

20. The non-transitory computer-readable medium of claim 17, wherein the second set of corporate data includes data maintained by the second autonomous data source that the user is authorized to access based on the user permission settings for the user.
